(19) United States
(12) Patent Application Publication
(10) Pub. No.: US 2014/0317024 A1
(43) Pub. Date: Oct. 23, 2014

(54) INTERNET-BASED PAPERLESS POSTAGE SYSTEM

(71) Applicant: ADVANCED TECHNOLOGY & RESEARCH CORP, Columbia, MD (US)

(72) Inventor: Robert Dana LUNDAHL, Frederick, MD (US)

(73) Assignee: ADVANCED TECHNOLOGY & RESEARCH CORP, Columbia, MD (US)

(21) Appl. No.: 14/255,616

(22) Filed: Apr. 17, 2014

Related U.S. Application Data
(60) Provisional application No. 61/812,939, filed on Apr. 17, 2013.

(51) Int. Cl. G06Q 50/32; G06K 9/00

(52) U.S. Cl. CPC G06Q 50/32; G06K 9/00469
USPC 705/407; 382/101

(57) ABSTRACT

A paperless postage method includes receiving sender electronic mail piece images and storing them, receiving a mail piece, taking an image of the mail piece, comparing the image with the stored sender electronic mail piece images to determine a match, retrieving sender service selections for the mail piece, and processing the mail piece according to the sender service selections. A paperless postage system includes an information reception and storage module configured to receive and store sender electronic mail piece images, an image capture module configured to take an image of a mail piece, an image matching module configured to compare the image with the stored sender electronic mail piece images to determine a match, a service selection module configured to retrieve sender service selections for the mail piece, and a mail piece processing module configured to process the mail piece according to the sender service selections for the mail piece.

This application claims the benefit of U.S. Provisional Application No. 61/812,939, filed Apr. 17, 2013, which is hereby incorporated by reference in its entirety.

### FIELD OF THE INVENTION

The present invention relates generally to an internet-based paperless postage system for letter and package shipping.

### BACKGROUND

For decades, the payment system for letter and package (collectively, “mail piece”) postage of the United States Postal Service (“USPS”) has been based on pre-paid stamps, authorized postage meter printed stamps, and payment taken and postage applied by USPS personnel at Post Office counters. This system has functioned acceptably for many years. However, it requires that physical proof of postage payment be applied to the mail piece before it enters the USPS processing and delivery system. Traditional postage stamps must be purchased by the customer (hereinafter “sender”) from the USPS or a designated retail outlet. The price of mailing changes regularly and it can be difficult for senders to determine the amount of postage required.

To mail large envelopes and packages, senders typically go to a Post Office, wait in line for assistance, have their item measured and weighed, select between different delivery options with the clerk, pay for the correct postage, and finally release their mail piece to the USPS. Many business offices enter contracts with USPS-authorized third parties to obtain their own postage metering devices, also known as franking machines. These third parties can charge high rents for their devices and related services. Senders with postage meters can weigh and classify their own mail pieces, and either stamp on the required postage or print it out and apply it to the mail piece. Postage fees are tracked on their metering device and paid periodically via the senders' accounts with the authorized third party.

A more recent extension of the franking machine approach is a software-based application whereby a home-based sender or small business can print labels and postage without dedicated mailing hardware. Providers include the USPS itself (Click-N-Ship application), as well as other commercial providers such as Stamps.com, Endicia and Pitney Bowes. Payment is made via a billing account with the software provider, or by credit card, bank account debit, PayPal or other third-party payment system. While these software applications are somewhat popular with frequent senders, they still require considerable effort and administration on the part of the sender before an item can be released to the shipper.

Commercial express letter and package carriers, such as UPS and Federal Express, offer counter-based mail piece acceptance, but rely more heavily on pre-arranged accounts with their senders. Occasional senders may also pay for postage by writing or printing credit card information and signature on the label, but the sender must first obtain the label forms of the particular shipper.

Establishing a different mail piece induction system that does not rely on physical stamps or pre-printed shipping forms would be of great convenience to infrequent senders, and would provide additional benefits to frequent senders and to the shippers themselves stemming from the possibilities offered by the creation of rich electronic data before an item is released to the shipper.

Innovations in mail piece postage systems will be of greater utility to senders and shippers to the extent that their enabling technologies are readily available at reasonable cost. Mass-produced hardware, reasonably mature software-based capabilities and public data communications networks enable rapid implementation of the innovation described herein.

### SUMMARY

It is to be understood that both the following summary and the detailed description are exemplary and explanatory and are intended to provide further explanation of the invention as claimed. Neither the summary nor the description that follows is intended to define or limit the scope of the invention to the particular features mentioned in the summary or in the description. Rather, the scope of the invention is defined by the appended claims.

In certain embodiments, the disclosed embodiments may include one or more of the features described herein.

A new internet-based mail piece postage system is more convenient for senders and offers service, revenue and operational benefits to shippers as well. It can be fully implemented and offered by the shipping organization itself, or it can be largely implemented by a 3^{rd} party who provides the system and postage payments to the shipper on a service basis. The system utilizes smartphones (or other computing devices), data communications networks, image processing, and electronic billing technologies integrated together as a system.

In this system, the sender may photograph his or her mail piece with a mobile device (e.g. smartphone, tablet, PDS, etc.) application, select desired mail services in the application, and send the information to the application's “mailbox” over the cellular or Wi-Fi network. The sender may then drop the mail piece into a general purpose receptacle of the shipper without physical postage or interaction with shipper service personnel. This alone is a major convenience and time-saver for senders. Non-mobile devices, e.g. desktop computers, may also be used by the sender, however if a mobile device is not used (at least at the drop-off point) some of the advantages of having sender location information may be lost. On the other hand, a sender may use a desktop computer to initiate a shipment and then sign-in or otherwise identify themselves at a drop-off point and thereby maintain the location information that is advantageous to the efficiency of the system.

The data transmission may also contain information about the sender's location at the time the image file is transmitted. On the shipper side, the mail piece may be optically imaged, i.e. photographed, as it enters the shipper's processing system. High quality cameras and scanners are increasingly used by shippers upon induction of mail pieces to create an electronic record of them. Mail pieces without postage may be compared with images stored in the shipper application database and a matching image may be found. It is not necessary that Optical Character Recognition (OCR) be used to read the handwriting or printing in order to make a match with the data file transmitted by the sender. Commercial image matching software is capable of making the match. However, an OCR function may also be performed at this point to capture the delivery address for use in subsequent mail processing and routing performed in the conventional manner, and/or to supplement the commercial image matching software, for example if a match is made but with a low confidence, or if matches are made to two or more different stored images.

Once the shipper-created image is matched with the sender's image, sender payment information and service selections may be uniquely associated with the mail piece and a unique tracking identifier may be created. Weight and size information about the mail piece may be collected in association with shipper imaging, so final shipping costs may be determined and applied to the sender's account or paid via third-party payment systems. A cost estimate may have been provided to the sender via the application at the time of selecting desired mail services, based on sender-input estimates/measurements of weight and size information for the shipped article. If such weight and size information has been supplied by the sender, it may also be used to help verify matches between mail pieces without postage and stored images. The shipper's downstream processing and delivery system may continue to use the image file to identify the package, or, per current processes, a conventional barcode may be printed and applied to the mail piece to allow it to be read throughout the shipper's system by standard barcode readers. The mail piece may then be routed to its recipient the same way as any other mail piece. The system greatly increases shipping convenience for the sender. The electronic file about the mail piece created by the shipper upon its induction may be used to provide a variety of package tracking and notification functions for the sender. For the shipper's part, the system can provide service up-selling opportunities and may generate revenues from location-sensitive advertising delivered to the smartphone or other device. The system also provides operationally useful information about mail piece origination even before the mail piece is inducted, and reduces the need for service counter labor.

In summary, the invention allows the sender to post mail pieces without postage or shipper-specific mailing labels, and utilize internet-enabled service enhancements within hours of surrendering a mail piece, while the shipper makes itself more attractive to senders, increases revenue from additional services and from smartphone advertising, and gains operational efficiencies.

A new computer-implemented paperless postage method is implemented in a computer system that includes one or more processors executing computer program modules, and includes receiving sender electronic mail piece images and storing them, receiving a mail piece, taking an image of the mail piece, comparing the image of the mail piece with the stored sender electronic mail piece images to determine a match, responsive to determining the match, retrieving sender service selections for the mail piece, and processing the mail piece according to the sender service selections for the mail piece.

In implementations, the method may further include receiving location information related to the mail piece, where receiving the mail piece comprises retrieving the mail piece from a location using the location information. Receiving the location information related to the mail piece may include capturing a location of a sender of the mail piece via the sender's mobile device GPS, cell service triangulation, and/or WiFi hotspot data. Receiving the location information related to the mail piece may include identifying a sender of the mail piece at drop-off and registering a location of the drop-off point.

In implementations, the method may include receiving sender service selections associated with the electronic mail piece images and storing them, determining the weight and/or size of the mail piece and billing a sender responsive to retrieving the sender service selections for the mail piece, and/or receiving and/or determining contact information for a recipient of the mail piece and sending a delivery status update to the recipient with at least one of the matched sender mail piece image, the image of the mail piece, and data designated by a sender of the mail piece to be transmitted to the recipient. The designated data may include audio and/or one or more images. The method may also include transmitting service options and pricing to a sender of the mail piece, where the pricing is determined at least in part based on at least one of the sender's previous shipping behavior, the sender's location, and sender demographic information, and receiving location information related to the mail piece, where comparing the image of the mail piece with the stored sender electronic mail piece images to determine a match includes comparing the image of the mail piece with stored sender electronic mail piece images having matching or similar location information.

The method may also include evaluating the received sender electronic mail piece images and determining whether they meet minimum standards for lighting, orientation, resolution, and/or address inclusion, and requesting a new image for sender electronic mail piece images that do not meet the minimum standards, and/or determining the match in part by using optical character recognition on text detected in the image of the mail piece and matching the text to address information received from a sender of the mail piece.

A new paperless postage system includes one or more processors configured to execute computer programs, the computer program modules including an information reception and storage module configured to receive and store sender electronic mail piece images, an image capture module configured to take an image of a mail piece, an image matching module configured to compare the image of the mail piece with the stored sender electronic mail piece images to determine a match, a service selection module configured to retrieve sender service selections for the mail piece, responsive to the match determination, and a mail piece processing module configured to process the mail piece according to the sender service selections for the mail piece.

In implementations, the information reception and storage module may be further configured to receive location information related to the mail piece by at least one of capturing a location of a sender of the mail piece via the sender's mobile device GPS, cell service triangulation, and/or WiFi hotspot data, and identifying the sender at drop-off and registering a location of the drop-off point, where comparing the image of the mail piece with the stored sender electronic mail piece images to determine a match comprises comparing the image of the mail piece with stored sender electronic mail piece images having matching or similar location information.

The information reception and storage module may be further configured to receive sender service selections associated with the electronic mail piece images and store them.

The image capture module may be further configured to determine the weight and/or size of the mail piece and the mail piece processing module may be further configured to bill a sender responsive to retrieving the sender service selections for the mail piece.

The information reception and storage module may be further configured to receive and/or determine contact information for a recipient of the mail piece and the mail piece processing module may be further configured to send a delivery status update to the recipient with at least one of the matched sender mail piece image, the image of the mail piece, and data designated by a sender of the mail piece to be transmitted to the recipient and comprising audio and/or one or more images.

The service selection module may be further configured to transmit service options and pricing to a sender of the mail piece, wherein the pricing is determined at least in part based on at least one of the sender's previous shipping behavior, the sender's location, and sender demographic information.

The image capture module may be further configured to evaluate the received sender electronic mail piece images and determining whether they meet minimum standards for lighting, orientation, resolution, and/or address inclusion, and request a new image for sender electronic mail piece images that do not meet the minimum standards.

The image matching module may be further configured to use optical character recognition on text detected in the image of the mail piece and match the text to address information received from a sender of the mail piece.

A new paperless postage system includes one or more processors configured to execute computer programs, the computer program modules including an information reception and storage module configured to receive and store sender electronic mail piece images and sender service selections associated with the electronic mail piece images and store them, and to receive location information related to a mail piece by at least one of capturing a location of a sender of the mail piece via the sender's mobile device GPS, cell service triangulation, and/or WiFi hotspot data, and identifying the sender at drop-off and registering a location of the drop-off point, an image matching module configured to compare a shipper image of the mail piece with stored sender electronic mail piece images having matching or similar location information to determine a match, and a service selection module configured to retrieve sender service selections for the mail piece, responsive to the match determination and transmit them to a shipper. This system may operate independently of a shipper, for example being operated by a third party intermediary between sender and shipper and receiving information from the sender and, in implementations, the shipper as well.

These and further and other objects and features of the invention are apparent in the disclosure, which includes the above and ongoing written specification, with the drawings.

### BRIEF DESCRIPTION OF THE DRAWINGS

The accompanying drawings, which are incorporated herein and form a part of the specification, illustrate exemplary embodiments and, together with the description, further serve to enable a person skilled in the pertinent art to make and use these embodiments and others that will be apparent to those skilled in the art. The invention will be more particularly described in conjunction with the following drawings wherein:

FIG. 1 is a block diagram for an internet based paperless postage system, in an embodiment.

FIG. 2 illustrates a system for a paperless postage system, in accordance with one or more implementations.

FIG. 3 illustrates a method for an internet based paperless postage system, in accordance with one or more implementations.

### DETAILED DESCRIPTION

An internet-based paperless postage system will now be disclosed in terms of various exemplary embodiments. This specification discloses one or more embodiments that incorporate features of the invention. The embodiment(s) described, and references in the specification to “one embodiment”, “an embodiment”, “an example embodiment”, etc., indicate that the embodiment(s) described may include a particular feature, structure, or characteristic. Such phrases are not necessarily referring to the same embodiment. When a particular feature, structure, or characteristic is described in connection with an embodiment, persons skilled in the art may affect such feature, structure, or characteristic in connection with other embodiments whether or not explicitly described.

In the several figures, like reference numerals may be used for like elements having like functions even in different drawings. The embodiments described, and their detailed construction and elements, are merely provided to assist in a comprehensive understanding of the invention. Thus, it is apparent that the present invention can be carried out in a variety of ways, and does not require any of the specific features described herein. Also, well-known functions or constructions are not described in detail since they would obscure the invention with unnecessary detail. Any signal arrows in the drawings/figures should be considered only as exemplary, and not limiting, unless otherwise specifically noted.

The description is not to be taken in a limiting sense, but is made merely for the purpose of illustrating the general principles of the invention, since the scope of the invention is best defined by the appended claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items. As used herein, the singular forms “a”, “an” and “the” are intended to include the plural forms as well, unless the context clearly indicates otherwise.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

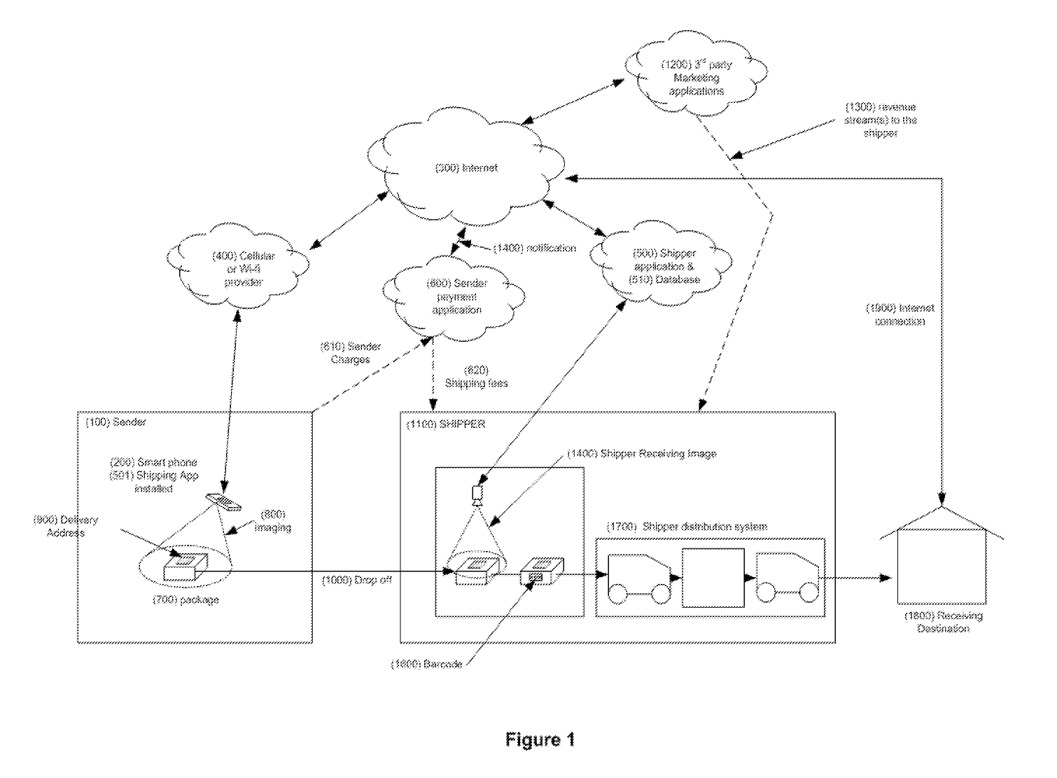

FIG. 1 shows the general description of an internet-based paperless postage system and illustrates the hardware and flow of communications for the sender and the shipper. This figure illustrates the mailing process and the flow of information in the general case of a sender giving a mail piece to a shipping organization. In the context of this description, the “shipper” can be the USPS, UPS, Federal Express, or any other standard or express mail organization, and the word “mail piece” means anything that is shipped from one location to another, from a pallet load or crate, to a parcel or single letter. In overview, the sender (100) has a smartphone (200) connected to the internet (300) via a cellular or WiFi provider (400). The sender has installed a shipper-supplied software application (501) to his smartphone (200) that establishes his link and interface to the cloud-based “shipper application” (500). The shipper application connects to a sender payment application (600) that appears to the sender as an integrated part of the shipper application. When the sender wants to post a mail piece (700), sender uses his smartphone device to image, i.e. photograph, (800) the mail piece with its delivery address (900) clearly visible. Features in the smartphone application guide the sender to capture an image optimized for image matching, and additional features may be provided to allow the sender to further distinguish or verify his package with additional markings, confirmation codes, or direct input of delivery address information. For example, the smartphone application might instruct the sender to mark a large X or other letter (or alphanumeric sequence, shape, etc.) in a given corner of the top surface (or other location) of the package, for easy identification by the shipper later on. The sender may also be prompted to enter some or complete delivery and/or return address information, to facilitate matching at the shipper facilities after the mail piece address(es) are determined using e.g. OCR or manual verification.

Once sufficient information about the mail piece has been captured, the sender may select shipping options in the application menu. This data, along with the mail piece image, sender identification, time, location, and other possible sender-input information is communicated through the Internet (300) to the shipper's server-based application and database (510). The sender then drops off the mail piece (1000) with the shipper (1100) in one of several fashions to be described. Other 3^{rd} party marketing applications (1200) may use the sender information from the shipper application (for example to send advertisements to the sender's smartphone), thus creating an advertising or other revenue stream for the shipper (1300).

Subsequently, the shipper images the postage-less mail piece (700) at or shortly after the time when the mail piece is physically inducted into the shippers processing system. The shipper image (1400) is transmitted electronically to the shipper application (500) and matched with the image (800) provided by the sender and stored in the database (510). A tracking number may be assigned to the mail piece. The shipper's equipment also weighs and sizes the mail piece.

The mail piece label is then machine-read (OCR), manually read, and/or delivery address information input by the sender is collected from the matched file, and a standard barcode label (1600) identifying the receiving destination (1800) is attached. This information, together with the service selections made by the sender (100), determines the price of postage, which is then charged to the sender via the sender payment application (600). The sender may be required to keep valid payment methods on file to cover the charges, and/or sufficient funds on account. The package (700) or mail piece enters the shippers' distribution system (1700) to be further processed and delivered. The recipient at the receiving destination (1800) and the sender (100) may access tracking information available through the shipper's application (500) and/or through the shipper's standardized, all-customers tracking system. The receiving destination (1800) may require some form of internet connection (1900) to access shipping information.

The steps in the process are described in more detail as follows.

The sender (100) can be an individual or any other type of entity having available a device with the shipper software application set up on it and an internet connection to transmit the information.

No particular type or make of smartphone or other mobile device (200) is required. Any device that is Internet-capable, supports browser applications, has a medium-or-better speed connection available when it is used for the service, and having a built-in flash camera of good imaging quality (e.g. 5 megapixels or better) works well, and other devices may also be acceptable. Most mass-produced smartphones meet these specifications, as do most tablet computers. Although the term smartphone is used herein, it should be understood to encompass other types of computing devices, including mobile devices such as tablet computers and ultrabooks.

Customers who wish to utilize this service may run a shipping software application (501) available for download from the website of the shipper or the shipper's third-party partner for the service. The application, which interfaces seamlessly with a cloud-based shipper application (500) and database (510), may perform several functions. One function is the choice of shipping services for the mail piece. The application may offer a menu selection of options which may include any shipper-mandated identification of the sender materials, different delivery priorities, e.g. regular, next day and weekend deliveries, immediate pick-up of the mail piece by the shipper, return receipt, as well as other services including but not limited to package tracking, email delivery notifications, and potentially other co-delivered features such as voice messages and images. If the sender inputs the recipient's email address, SMS number, and/or similar, or if the recipient can be identified and such information determined by the shipper (for example if the recipient has an account and profile with the shipper), the recipient at the sender and/or recipient's option may be notified by email, SMS, etc. when a mail piece is delivered for them and/or when the mail piece is dropped off, first identified by the shipper, and/or at other points prior to delivery. The same notifications may be made to the sender where the sender's contact information is known, and the notifications may be sent according to sender preferences (e.g. the sender may choose not to receive notifications, or to only receive notification of delivery and/or some other steps prior to delivery, only for items of a certain size and/or of a certain value and/or shipped at a certain cost, etc.). When notification of delivery (and/or with notification of some other stage of shipment) is made to a recipient, the image taken by the sender and/or shipper may also be sent, e.g. by email or text, to facilitate ease of identification of the mail piece by the recipient, and/or some other information such as text or audio submitted by the sender for that purpose.

Another important function is mail piece imaging. The application and the software of the smartphone camera may interact to assure that the sender takes a photograph of the mail piece that is of sufficient quality for later image matching. Quality standards include capture of identifying portions (e.g. addresses, any identifying markings made to the mail piece) or the entirety of the mail piece, lighting, orientation, resolution and lack of image distortion. For example the picture may be required to have a certain minimum lighting level, a straight-on orientation, a certain minimum resolution, and/or include two addresses. The image quality check may be performed by the local software on the smartphone, and/or by the web-based shipper application immediately after the image is sent to the application. The application may require that images of insufficient quality be re-taken and re-submitted.

Other options to identify the mail piece and specify the delivery address may be presented to the sender. For example, the sender may elect to key in enough of the delivery address for the shipper to generate a standard barcode for the mail piece upon induction. This additional effort by the sender may be compensated by a discount in the postage price. The shipper application identifies the sender and time when connection is made to the application. Subject to the sender's permission and applicable privacy regulations, the application may also capture the sender's location via the smartphone's GPS, cell-triangulation, and/or WiFi hotspot data at the time the application is used. Collectively, these features facilitate the shipper's essential tasks when the mail piece is received, and may qualify the sender for additional discounts or service features.

The mail piece is then dropped at a location where it is picked up by the shipper. Many different drop-off locations (1000) are possible. In early stages of rollout and adoption of the system, drop-offs may be allowed only at an unmanned counter inside a shipper facility, i.e. a Post Office, or at a mail chute inside or outside such facility. No waiting for human or machine-based service is required. However, the system concept also includes shippers with other drop-off locations, such as drive-by collection boxes, home or business pick-up locations, and 3^{rd} party retail establishments. Given the time and location data provided by the sender, even an arbitrary geo-location for drop-off is possible (e.g. the sender could drop the package off behind the reception desk at any office building or at any other mail delivery location and the shipper could locate the package using the location information and pick it up, for example when delivering other mail to that location). To facilitate collections by the shipper, the sender may also image a barcode, QR code, or some other identifying symbol associated with the collection point. For example, an unmanned counter in a shipping facility may have a prominent QR or barcode and the sender may be prompted to image this code when he arrives at the counter to drop off the mail piece, which is then transmitted on to the shipper with the other mail piece information.

The shipper may take physical custody of the mail piece at any prescribed location and perform a “shipper receiving imaging” (1400) of it. The shipper image may be taken at a variety of locations. This may be for example in the Post Office, for a mail piece to be sent by the USPS, or a mobile device may image the mail piece immediately at the pickup point at a roadside collection box, home, office, 3^{rd} party retail establishment, or any other geo-location, as notified by the shipper application and its database. For example, a shipper employee may arrive at the location to pick up mail pieces for processing, and use a mobile device such as a dedicated package imager or a smartphone or other mobile device with an installed shipper imaging application to image any packages without postage. If imaged at a mail processing facility, controlled environmental conditions result in a consistently usable image. If imaged outside a facility, the shipper's mobile imaging equipment may contain image quality checking features, similar to those built into the sender's interface. This image is communicated to the shipper application (500) and a search is performed in its database (510) for a matching image. Many different software packages, methods and algorithms are available to process imagery and compare it with images stored in a database, and more are anticipated in the future. These commercial applications may be used and optimized for the specific application of comparing two images of the same article and address label with anticipated differences in lighting, orientation, size, field of view, aspect ratio, and perpendicularity between camera and label. An example of a sophisticated image recognition engine is “TinEye” offered by Idée Inc.

The image matching task may be facilitated by the time and location information associated with the sender-generated image and shipper-generated image, which greatly narrows down the number of images to be examined for a match. Where the sender scans a code at the drop-off location as described above, the exact drop-off location is known and only images corresponding to that drop-off location need to be searched. Other methods may be used for the same purpose besides code-scanning, for example having the sender enter a code or login information into a terminal at the drop-off location. A problem may occur if a sender shipping multiple mail pieces drops those mail pieces off at multiple drop-off locations, such that the multiple mail pieces may be confused, which however should be extremely rare (for example if a sender forgets one mail piece in their car and does not realize it until later), and may be resolved by matching against other images taken around the same time by the same shippers. Where a shipper images one mail piece and drops off another, if this mail piece is the only mail piece dropped off at a given location within a given time period, or the only such mail piece that is unmatched, the sender may be determined accordingly and contacted to notify them of the issue. Even with multiple unmatched mail pieces, all senders who indicated a mail piece drop-off but who were not matched to a mail piece from the shipper's side may be contacted to inform them of the lack of a match, and may be given the opportunity to review the unmatched mail pieces to determine if one is theirs, subject to further verification. Where location information is gathered from the sender at the time of drop-off (e.g. by GPS), the exact drop-off location should be known, however there may be errors introduced by the location gathering methods and/or sender error (e.g. indicating drop-off occurred before or after actual drop-off). Where the exact drop-off location is known, only in cases of a sender dropping off large quantities of nearly identical mail pieces with very similar or the same addressees would matching become problematic. In such cases, the addition by the sender of a small, but unique, hand mark to each mail piece is sufficient to differentiate the pieces. In other scenarios, a sender's location may be determined when the app is used, but not necessarily at the time of drop-off. In that case, matching may begin at drop-off points nearest that location and radiate outwards, generally greatly reducing matching difficulty compared to global matching against all sent mail pieces everywhere.

When the matching image is found, the sender identity, service requests and/or billing information associated with that package become available to the shipper. Other information about the package, such as weight and size, are collected by the shipper using automated equipment or manually when the mail piece is inducted into the shipper's processing system. Final shipping costs may be computed and applied to the users account or charged via payment intermediary at that time. In some embodiments, an initial payment may be made at the time of sending based on sender-supplied weight/size and upon shipper verification the payment amount may be changed by making an additional charge or sending a partial refund. Although the shippers' distribution system (1700) can continue to use the matched image file to identify and route the package, a conventional barcode may be printed and applied to the mail piece at the induction stage to allow it to be read throughout the system by standard barcode readers. The mail piece may thus be routed to its destination the same as any other item. The bar-coded item and existing barcode infrastructure support a variety of package tracking displays and notifications for the sender and the receiving party through the shipper application or through the shipper's universal tracking system.

The payment of shipping charges is managed by the sender payment application (600) that contains an electronic payment module that allocates sender charges(610), based on the shipper receiving image (1400) and notification from the shipper application(500). Actual shipping revenue (620) to the shipper (1100) is managed by the sender payment application (600) and transferred using standard methods of making secure, mobile electronic payments. The most basic method involves a billing account set up between the sender and the shipper. This method may be the most attractive to business senders that support multiple users of the service over multiple devices, but with a single billing account. More convenient for individual senders are payment systems intermediated by a cellular service provider charging the sender via the cellphone account, by banks via credit card or debit card information pre-loaded into the application, and so-called “online wallets” offered by PayPal® (eBay®), Amazon® and Google®. Existing home-print postage applications, e.g. USPS Click-N-Ship, and Stamps.com, support multiple methods of payment.

This internet-based paperless postage system in various implementations offers several benefits to the sender and the shipper. The driving benefit for both is the ease and convenience for senders that attract more business for the shipper. This system also provides multiple opportunities for the shipper to sell more and more customized services to the sender. Senders can choose a variety of features and enhanced services presented on the smartphone application interface. In addition to the standard class of service options, the internet-based interface facilitates the introduction of time and location-sensitive service and pricing offers for yield management purposes. The pricing displayed by the app may vary based on time and location, and further, discounts may be offered on various services, the amount of which may be based on the same criteria. Pricing and discounts may also vary based on observed sender shipping patterns (e.g. amount of pieces shipped over a period of time, average shipping costs incurred over a period of time, locations shipped to, types of mail pieces sent, etc.), and other information known about the sender, such as whether it is a person or a business, what type of device it is using, and demographic information (e.g. gender, age, region of residence, job, hobbies, marital status, etc.). Internet-based conveniences, such as email notifications and attached voicemail files for mail piece recipients, may also be provided.

Sender time and location information generated by the application, and cumulative information about the nature of the sender's mailing activities (types of mail pieces sent, volume of shipping, etc.), as well as information input by the seller such as personal/business account, type of business, demographic information, etc. also provide data that can be monetized by 3rd party marketers (1200) and additional revenue streams (1300) can be established for the shipper (1100). Advertising and incentives to visit other merchants near the sender at the time of mailing may be delivered to the mobile device and retail establishments may offer the sender (100) discounts to drop off packages at their own locations. These and other commercial entities may offer additional revenue (1300) to the shipper based on the marketing value of the information about the sender (100) that can be provided from the shipper application (500) and database (510).

In addition, the time and location information has operational benefits for the shipper, reducing service counter labor, and helping the shipper to anticipate volumes of mail pieces for induction throughout the shipper's distribution system and efficiently schedule pickups from remote drop locations.

This internet-based paperless postage system may also be provided by a third party as a service to the shipper where the shipper, the sender, and/or other third-party party marketers pay the third party for the services provided. Independent business services centers, such as Mail Boxes Etc., are well positioned for such a role.

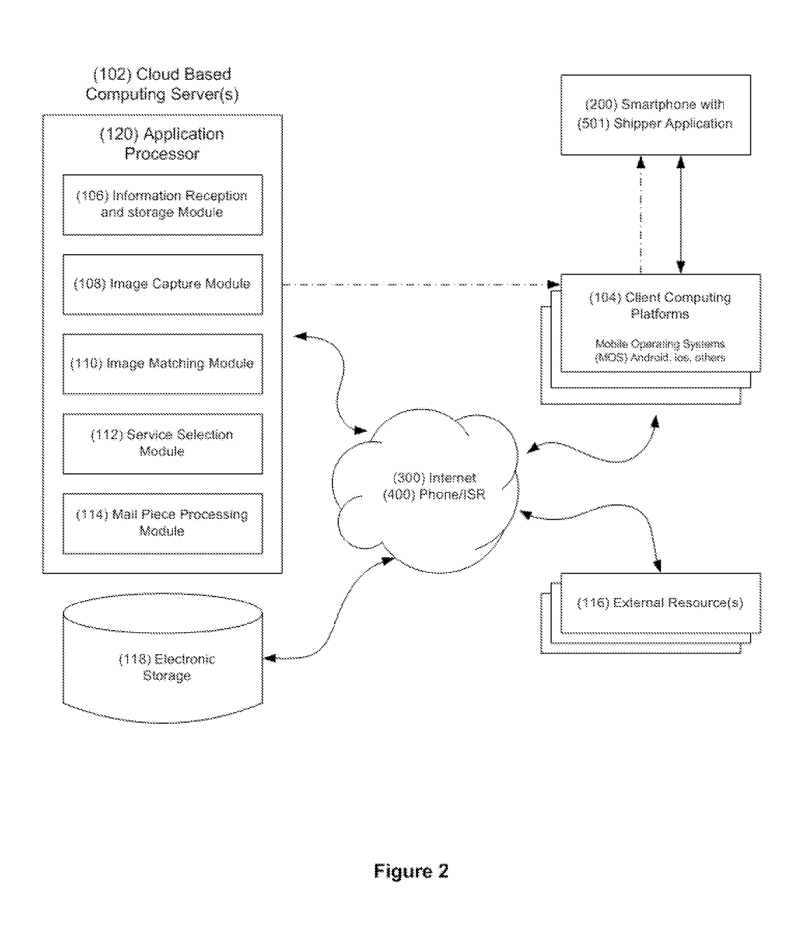

FIG. 2 describes one implementation of a system architecture to provide a paperless postage system based on one or more cloud based computing servers (102). In other implementations, the servers may not be cloud-based. These cloud based servers (102) may be configured to communicate with one or more client computing platforms (104), such as customer/sender mobile devices, according to a client/server architecture. Users may access the overall paperless postage system via client computing platforms (104) to ship a package.

The cloud based computing servers (102) may be configured to execute one or more computer program modules. The computer program modules may include one or more of an information reception and storage module (106), an image capture module (108), an image matching module (110), a service selection module (112), a mail piece processing module (114), and/or other modules. As noted, the client computing platform(s) (104) may include one or more computer program modules that are the same as or similar to the computer program modules of the cloud based computing server(s) (102) to facilitate sender actions.

The information reception and storage module (106) may be configured to receive and store electronic mail piece images. The information reception and storage module (106) may further be configured to receive location information related to a mail piece. The location information may be received by at least one of capturing a location of a sender of the mail piece via the sender's mobile device GPS, cell service triangulation, and/or WiFi hotspot data, and identifying the sender at drop-off and registering a location of the drop-off point. The information reception and storage module (106) may further be configured to receive sender service selections associated with the electronic mail piece images and store them. The information reception and storage module (106) may further be configured to receive and/or determine contact information for a recipient of the mail piece. Contact information may be determined for example by using OCR on the delivery address and matching the address to publicly available databases and/or customer information. In other implementations, some or all of this functionality may be handled by separate stand-alone modules, e.g. a sender service selection reception module, location information capturing/reception module, recipient contact information determination/reception module, etc.

The image capture module (108) may be configured to take an image of a mail piece. The image capture module (108) may further be configured to determine the weight and/or size of the mail piece, using for example a scale and/or measuring device. In other implementations, some or all of this functionality may be handled by separate stand-alone modules, e.g. a weighing and/or sizing module, etc.

The image matching module (110) may be configured to compare the image of the mail piece with the stored electronic mail piece images to determine a match. The image matching module (110) may be configured to perform the comparison with stored sender electronic mail piece images having matching or similar location information to the mail piece. The image matching module (110) may further be configured to evaluate the received sender electronic mail piece images and determining whether they meet minimum standards for lighting, orientation, resolution, and/or address inclusion, and request a new image for sender electronic mail piece images that do not meet the minimum standards. The image matching module (110) may further be configured to use optical character recognition on text detected in the image of the mail piece and match the text to address information received from a sender of the mail piece. In other implementations, some or all of this functionality may be handled by separate stand-alone modules, e.g. an image evaluation module, an OCR matching module, etc.

The service selection module (112) may be configured to retrieve sender service selections for the mail piece, responsive to the match determination. The service selection module (112) may further be configured to transmit service options and pricing to a sender of the mail piece. The pricing may be determined at least in part based on at least one of the sender's previous shipping behavior, the sender's location, and sender demographic information. In other implementations, some or all of this functionality may be handled by separate stand-alone modules, e.g. a service option transmission module, pricing module, etc.

The mail piece processing module (114) may be configured to process the mail piece according to the sender service selections for the mail piece. The mail piece processing module (114) may further be configured to bill a sender responsive to retrieving the sender service selections for the mail piece. The mail piece processing module (114) may further be configured to send a delivery status update to the recipient with at least one of the matched sender mail piece image, the image of the mail piece, and data designated by a sender of the mail piece to be transmitted to the recipient. Such designated data may include audio and/or one or more images. In other implementations, some or all of this functionality may be handled by separate stand-alone modules, e.g. a delivery status update module, billing module, etc.

In implementations where the system is maintained by a third party separate from the shipper, shipper imaging of the mail pieces and/or processing of the mail piece according to sender service selections may be carried out by the shipper. Thus, image capture module (108) and/or mail piece processing module (114) may be unnecessary and may not be on the application processor (120), and may be replaced by modules for receiving the shipper mail piece image for matching and for transmitting the retrieved sender service selections to the shipper for handling (or such functionality may be carried out by existing modules such as information reception and storage module (106) and/or service selection module (112)). In some such implementations, shipper mail piece imaging may still be handled by the system and third party, for example where the third party runs the drop-off locations or has hardware installed at the drop-off locations that enables it to take the incoming mail piece image for the shipper.

In some implementations, cloud based computing server(s) (102), client computing platforms (104), and/or external resources (116) may be operatively linked via one or more electronic communication links. For example, such electronic communication links may be established, at least in part, via a network such as the Internet (300) and/or other networks. The network may be a wired or wireless network such as the Internet (300), an intranet, a LAN, a WAN, a cellular network (400) or another type of network. It will be understood that the network may be a combination of multiple different kinds of wired or wireless networks. It will be appreciated that this is not intended to be limiting, and that the scope of this disclosure includes implementations in which cloud based computing server(s) (102), client computing platforms (104), and/or external resources (116) may be operatively linked via some other communication media.

A given client computing platform (104) may include one or more processors configured to execute computer program modules. The computer program modules may be configured to enable an expert or user associated with the given client computing platform (104) to interface with the overall system and/or external resources (116), and/or provide other functionality attributed herein to client computing platforms (104). By way of non-limiting example, the given client computing platform (104) may include one or more of a desktop computer, a laptop computer, a handheld computer, a tablet computing platform, a NetBook, a Smartphone, a gaming console, and/or other computing platforms.

External resources (116) may include sources of information, hosts and/or providers of virtual environments outside of the overall system, external entities participating with the overall system, and/or other resources. For example, external resources (116) may include certain mail piece delivery service equipment, such as postal service cameras/optical devices that upload mail piece images, postal service bar scanners and scales that transmit mail piece weight and other information, etc. In some implementations, some or all of the functionality attributed herein to external resources (116) may be provided by resources included in the overall system.

Cloud based computing servers (102) may include electronic storage (118), one or more Application Processor (120) and/or other components. The cloud based computing servers (102) may include communication lines, or ports to enable the exchange of information with a network and/or other computing platforms. Illustration of the cloud based computing servers (102) in FIG. 1 is not intended to be limiting. The cloud based computing servers (102) may include a plurality of hardware, software, and/or firmware components operating together to provide the functionality attributed herein to cloud based computing servers (102). For example, the cloud based computing servers (102) may be implemented by a cloud of computing platforms operating together as the cloud based computing servers (102).

Electronic storage (118) may comprise non-transitory storage media that electronically stores information. The electronic storage media of electronic storage (118) may include one or both of system storage that is provided integrally (i.e., substantially non-removable) with cloud based computing servers (102) and/or removable storage that is removably connectable to server servers via, for example, a port (e.g., a USB port, a firewire port, etc.) or a drive (e.g., a disk drive, etc.). Electronic storage (118) may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage (118) may include one or more virtual storage resources (e.g., cloud storage, a virtual private network, and/or other virtual storage resources). Electronic storage (118) may store software algorithms, information determined by Application Processor (120), information received from cloud based computing servers (102), information received from client computing platforms(104), and/or other information that enables cloud based computing servers(102) to function as described herein.

The Application Processor (120) are configured to provide information processing capabilities in the cloud based (102) computing servers. As such, the Application Processor (120) may include one or more of a digital processor, an analog processor, a digital circuit designed to process information, an analog circuit designed to process information, a state machine, and/or other mechanisms for electronically processing information. Although the Application Processor (120) is shown in FIG. 1 as a single entity, this is for illustrative purposes only. In some implementations, the Application Processor (120) may include a plurality of processing units. These processing units may be physically located within the same device, or the Application Processor (120) may represent processing functionality of a plurality of devices operating in coordination. The Application Processor (120) may be configured to execute modules 106, 108, 110, 112 and 114. The Application Processor (120) may be configured to execute modules 106, 108, 110, 112 and 114 by software; hardware; firmware; some combination of software, hardware, and/or firmware; and/or other mechanisms for configuring processing capabilities on the Application Processor (120). As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules (106, 108, 110, 112 and 114) are illustrated in FIG. 2 as being implemented within a single processing unit, in implementations in which the Application Processor (120) includes multiple processing units, one or more of modules (106, 108, 110, 112, and 114) may be implemented remotely from the other modules. The description of the functionality provided by the different modules (106, 108, 110, 112 and 114) is for illustrative purposes, and is not intended to be limiting, as any of modules (106, 108, 110, 112 and 114) may provide more or less functionality than is described. For example, one or more of modules (106, 108, 110, 112 and 114) may be eliminated, and some or all of its functionality may be provided by other ones of modules (106, 108, 110, 112 and 114). As another example, the Application Processor (120) may be configured to execute one or more additional modules that may perform some or all of the functionality attributed below to one of modules (106, 108, 110, 112 and 114). Other functionality described with respect to FIG. 1 and not explicitly indicated as being performed by one or more of modules (106, 108, 110, 112 and 114) may nevertheless be performed by one or more of those modules, or by other modules not expressly disclosed.

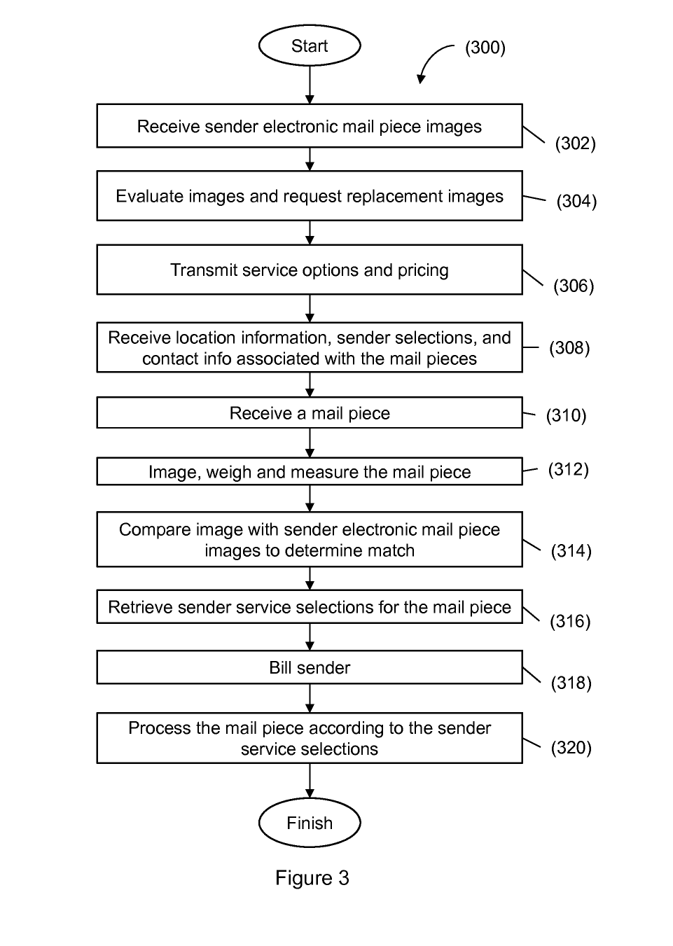

FIG. 3 illustrates a method (300) for an internet based paperless postage system. The operations of method (300) presented below are intended to be illustrative. In some embodiments, method (300) may be accomplished with one or more additional operations not described, and/or without one or more of the operations discussed. Additionally, the order in which the operations of method (300) are illustrated in FIG. 3 and described below is not intended to be limiting.

In some embodiments, method (300) may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method (300) in response to instructions stored electronically on an electronic storage medium. The one or more processing devices may include one or more devices configured through hardware, firmware, and/or software to be specifically designed for execution of one or more of the operations of method (300).

At an operation (302), electronic mail piece images are received from mail piece senders and stored. Operation (302) may be performed by a module that is the same as or similar to information reception and storage module (106), in accordance with one or more implementations.

At an operation (304), the mail piece images received from the senders are evaluated to determine if they meet minimum requirements for matching accuracy. The received sender electronic mail piece images may be evaluated to determine whether they meet minimum standards for lighting, orientation, resolution, and/or address inclusion, and replacement images may be requested for sender electronic mail piece images that do not meet the minimum standards. Operation (304) may be performed by a module that is the same as or similar to image matching module (110) and/or information reception and storage module (106), in accordance with one or more implementations.

At an operation (306), service options and pricing are transmitted to mail piece senders. The pricing may be determined at least in part based on at least one of the sender's previous shipping behavior, the sender's location, and sender demographic information. Operation (306) may be performed by a module that is the same as or similar to service selection module (112), in accordance with one or more implementations.

At an operation (308), location information, sender selections, and/or recipient contact information associated with the mail pieces are received. Pickups of mail pieces may be arranged based on received location information. For example, if received location information indicates that many mail pieces were dropped off for shipping at a given drop-off box, a truck may be sent to pick up the mail pieces dropped off there before the box overflows, etc. The location information related to the mail pieces may be retrieved by capturing a location of a sender of the mail piece via the sender's mobile device GPS, cell service triangulation, and/or WiFi hotspot data, and/or by identifying a sender of the mail piece at drop-off and registering a location of the drop-off point. Operation (308) may be performed by a module that is the same as or similar to information reception and storage module (106), in accordance with one or more implementations.

At an operation (310), a mail piece is received for shipment, for example at a drop-off counter, box, kiosk, retail establishment, or the like.

At an operation (312), the received mail piece is imaged, weighed and measured. Operation (312) may be performed by a module that is the same as or similar to image capture module (108), in accordance with one or more implementations.

At an operation (314), the image of the mail piece is compared with the stored electronic mail piece images received from the senders to determine a match. Stored electronic mail piece images having matching or similar location information may be compared first for efficiency. Optical character recognition may also be used on text detected in the image of the mail piece and matched to address information received from a sender of the mail piece to facilitate the matching process. Operation (314) may be performed by a module that is the same as or similar to image matching module (110), in accordance with one or more implementations.

At an operation (316), sender service selections for the mail piece are retrieved based on the match. Operation (316) may be performed by a module that is the same as or similar to service selection module (112), in accordance with one or more implementations.

At an operation (318), the sender is billed based on the retrieved service selections and the size and/or weight of the mail piece. Operation (318) may be performed by a module that is the same as or similar to mail processing module (114), in accordance with one or more implementations.

At an operation (320), the mail piece is processed according to the sender service selections. This may include sending a delivery status update to the recipient with the matched sender mail piece image, the image of the mail piece, and/or data designated by a sender of the mail piece to be transmitted to the recipient. The designated data may include audio and/or one or more images, which may be sent by email, SMS, automated phone call, etc. Operation (320) may be performed by a module that is the same as or similar to mail piece processing module (114), in accordance with one or more implementations.

The invention is not limited to the particular embodiments illustrated in the drawings and described above in detail. Those skilled in the art will recognize that other arrangements could be devised, for example, using various network architectures, types of software applications, etc. The invention encompasses every possible combination of the various features of each embodiment disclosed. One or more of the elements described herein with respect to various embodiments can be implemented in a more separated or integrated manner than explicitly described, or even removed or rendered as inoperable in certain cases, as is useful in accordance with a particular application While the invention has been described with reference to specific illustrative embodiments, modifications and variations of the invention may be constructed without departing from the spirit and scope of the invention as set forth in the following claims.

I claim:

1. A computer-implemented paperless postage method, the method being implemented in a computer system that includes one or more processors executing computer program modules, the method comprising:
receiving sender electronic mail piece images and storing them;
receiving a mail piece;
taking an image of the mail piece;
comparing the image of the mail piece with the stored sender electronic mail piece images to determine a match;
responsive to determining the match, retrieving sender service selections for the mail piece; and
processing the mail piece according to the sender service selections for the mail piece.

2. The method of claim 1, further comprising receiving location information associated with the mail piece, wherein receiving the mail piece comprises retrieving the mail piece from a location using the location information.

3. The method of claim 2, wherein receiving the location information related to the mail piece comprises capturing a location of a sender of the mail piece via the sender's mobile device GPS, cell service triangulation, and/or WiFi hotspot data.

4. The method of claim 2, wherein receiving the location information related to the mail piece comprises identifying a sender of the mail piece at drop-off and registering a location of the drop-off point.

5. The method of claim 1, further comprising receiving sender service selections associated with the electronic mail piece images and storing them.

6. The method of claim 1, further comprising determining the weight and/or size of the mail piece and billing a sender responsive to retrieving the sender service selections for the mail piece.

7. The method of claim 1, further comprising receiving and/or determining contact information for a recipient of the mail piece and sending a delivery status update to the recipient with at least one of the matched sender mail piece image, the image of the mail piece, and data designated by a sender of the mail piece to be transmitted to the recipient.

8. The method of claim 7, wherein the designated data comprises audio and/or one or more images.

9. The method of claim 1, further comprising transmitting service options and pricing to a sender of the mail piece, wherein the pricing is determined at least in part based on at least one of the sender's previous shipping behavior, the sender's location, and sender demographic information.

10. The method of claim 1, further comprising receiving location information related to the mail piece, wherein comparing the image of the mail piece with the stored sender electronic mail piece images to determine a match comprises comparing the image of the mail piece with stored sender electronic mail piece images having matching or similar location information.

11. The method of claim 1, further comprising evaluating the received sender electronic mail piece images and determining whether they meet minimum standards for lighting, orientation, resolution, and/or address inclusion, and requesting a new image for sender electronic mail piece images that do not meet the minimum standards.

12. The method of claim 1, wherein determining the match further comprises using optical character recognition on text detected in the image of the mail piece and matching the text to address information received from a sender of the mail piece.

13. A paperless postage system, comprising:
one or more processors configured to execute computer programs, the computer program modules comprising:
an information reception and storage module configured to receive and store sender electronic mail piece images;
an image capture module configured to take an image of a mail piece;
an image matching module configured to compare the image of the mail piece with the stored sender electronic mail piece images to determine a match;
a service selection module configured to retrieve sender service selections for the mail piece, responsive to the match determination; and
a mail piece processing module configured to process the mail piece according to the sender service selections for the mail piece.

14. The system of claim 13, wherein the information reception and storage module is further configured to receive location information related to the mail piece by at least one of capturing a location of a sender of the mail piece via the sender's mobile device GPS, cell service triangulation, and/or WiFi hotspot data, and identifying the sender at drop-off and registering a location of the drop-off point, wherein comparing the image of the mail piece with the stored sender electronic mail piece images to determine a match comprises comparing the image of the mail piece with stored sender electronic mail piece images having matching or similar location information.

15. The system of claim 13, wherein the information reception and storage module is further configured to receive sender service selections associated with the electronic mail piece images and store them.

16. The system of claim 13, wherein the image capture module is further configured to determine the weight and/or size of the mail piece and the mail piece processing module is further configured to bill a sender responsive to retrieving the sender service selections for the mail piece.

17. The system of claim 13, wherein the information reception and storage module is further configured to receive and/or determine contact information for a recipient of the mail piece and the mail piece processing module is further configured to send a delivery status update to the recipient with at least one of the matched sender mail piece image, the image of the mail piece, and data designated by a sender of the mail piece to be transmitted to the recipient and comprising audio and/or one or more images.

18. The system of claim 13, wherein the service selection module is further configured to transmit service options and pricing to a sender of the mail piece, wherein the pricing is determined at least in part based on at least one of the sender's previous shipping behavior, the sender's location, and sender demographic information.

19. The system of claim 13, wherein the image matching module is further configured to evaluate the received sender electronic mail piece images and determining whether they meet minimum standards for lighting, orientation, resolution, and/or address inclusion, and request a new image for sender electronic mail piece images that do not meet the minimum standards.

20. The system of claim 13, wherein the image matching module is further configured to use optical character recognition on text detected in the image of the mail piece and match the text to address information received from a sender of the mail piece.

21. A paperless postage system, comprising:
one or more processors configured to execute computer programs, the computer program modules comprising:
an information reception and storage module configured to receive and store sender electronic mail piece images and sender service selections associated with the electronic mail piece images and store them, and to receive location information related to a mail piece by at least one of capturing a location of a sender of the mail piece via the sender's mobile device GPS, cell service triangulation, and/or WiFi hotspot data, and identifying the sender at drop-off and registering a location of the drop-off point;
an image matching module configured to compare a shipper image of the mail piece with stored sender electronic mail piece images having matching or similar location information to determine a match; and
a service selection module configured to retrieve sender service selections for the mail piece, responsive to the match determination and transmit them to a shipper.
